(19) United States
(12) Patent Application Publication
(10) Pub. No.: US 2012/0107574 A1
(43) Pub. Date: May 3, 2012

(54) METHOD FOR APPLYING A SHRINK LABEL TO AN ARTICLE, A SHRINK LABEL AND A SHRINK LABEL MATERIAL

(75) Inventor: Noel Mitchell, Wuppertal (DE)

(73) Assignee: UPM Ralflatac Oy, Tampere (FI)

(21) Appl. No.: 13/265,685

(22) PCT Filed: Apr. 21, 2009
(86) PCT No.: PCT/FI09/50301

§ 371 Date: Jan. 3, 2012

(51) Int. Cl. B32B 3/00; B32B 7/12; B32B 38/00; B32B 37/14; B32B 38/08

(52) U.S. Cl. 428/195.1; 156/84; 156/73.1; 428/355 N

(57) ABSTRACT

A method for applying a shrink label to an article, a shrink label and a shrink label material.

### FIELD OF THE INVENTION

The present invention relates to a method for applying a shrink label to an article. The invention also relates to a shrink label and a shrink label material to be used in the method according to the invention.

### BACKGROUND OF THE INVENTION

Shrink labels are known in the art in the form of pre-formed sleeves constructed from film material that shrinks when heat is applied and thus after such a sleeve has been arranged on an article, such as a container, it will conform to the shape of the container when finally fitted on the container using a proper amount of heat. Another type of shrink-labels are so called roll-applied shrink labels which are not separately pre-formed sleeves. Roll-applied shrink labels are first formed on the container by adhering the leading edge of the label film to the container with adhesive and then after arranging the label film loosely around the container, adhering further the trailing edge of the film to the leading edge of the film with adhesive. Thus, the sleeve is formed directly on the container and then shrunk with heat to make a proper tight fit. Roll-applied shrink-labels are also widely known as such and they are typically used for simple containers with a relatively low shrink demand. Typically, such roll-applied shrink labels do not shrink in practical applications more than approximately 15%. This low shrinkage performance restricts the applicability of the labels for some otherwise potential applications.

Nowadays, machine direction oriented polyolefin roll-applied shrink films are also available with higher shrink performance. However, despite this higher shrinkage performance there are still major technical issues preventing their applicability for all applications. In the case of roll-applied shrink-labels, the leading edge of the label needs to be adhered with an adhesive to the container, and the trailing edge also needs to be adhered to this leading edge with adhesive. However, with high shrink demand and in particular with the use of steam-shrink tunnels, the forces on these adhesive joints are so strong that the seams tend not to hold together at these high temperatures of 95° C. or greater.

This naturally also applies to labels provided in the form of pre-formed shrinkable sleeves if the sleeves have been formed using an adhesive seam.

Therefore, the issue of adhesive seaming for shrink label systems requiring more than about 20% shrinkage remains unsolved.

Current shrink label adhesive systems are based on either conventional block-copolymer rubber systems or UV-cured systems which need to be both applied at the point of label application and in the case of UV-curable systems, cured by expensive and space-consuming UV-curing apparatus.

Furthermore, the vast majority of shrink-sleeves used today are based on either polyvinyl chloride, polyester glycol terephthalate or polystyrene systems. All these polymers have a density greater than 1.0 g/cm³ and therefore cannot be separated from polyester bottles in the normal polyester flotation recycling processes due to the fact that the high density material will not float in the washing liquid. Therefore, systems with a density lower than 1.0 g/cm³ would also be highly desirable, particularly if these were machine direction oriented so that they could be applied by the faster and more economical roll-applied method.

### SUMMARY OF THE INVENTION

The invention aims at alleviating the above mentioned problems resulting from the use of higher shrinkage film materials that will also have seams formed by adhesives which seams need to be able to handle the final heat shrinking of the label on an article, e.g. on a container. Thus, the aim of the present invention is to provide a novel method for applying a machine direction oriented shrink label onto an article, such as a container. The aim of the invention is also to provide a shrink label applicable onto the article and a shrink label material to be used in the method according to the invention.

To achieve these aims, the method according to the invention for applying a shrink label to an article is characterized in that the method comprises at least the steps of:
introducing a shrink label material comprising a machine direction oriented polyolefin shrink film coated substantially over one surface of the film with activatable polyurethane adhesive,
printing the non-activated polyurethane adhesive layer of the label material except for at least one edge of the label material reserved for a seam to form a shrinkable label sleeve,
activating the polyurethane adhesive locally at the non-printed edge of the label material and bonding the edges of the label material to form the shrinkable label sleeve, and
shrinking the sleeve as the shrink label over the article.

The invention can be used together with pre-formed label sleeves or roll-applied shrink labels, where the sleeve is formed upon the application of the label on the article.

In the case of the pre-formed sleeves, a shrink label material comprising a polyolefin film coated with the activatable polyurethane adhesive is printed except for one edge of the label material reserved for an overlapping joint to form a sleeve. After printing, the polyurethane adhesive is activated locally at the non-printed edge of the label material and bonded overlapplingly to the opposite edge of the label material. The pre-formed sleeve is arranged and shrunk over the container.

Another embodiment of the method according to the invention is roll-applied shrink labels, i.e. sleeves formed in situ over the article. In this case, the method for applying the shrink label to an article comprises at least the steps of:
introducing a shrink label material comprising a machine direction oriented polyolefin shrink film coated substantially over one surface of the film with activatable polyurethane adhesive,
printing over the non-activated polyurethane adhesive layer except for the leading edge of the label material to be attached to the article and for the trailing edge reserved for a seam for bonding the trailing edge to the leading edge,
activating the polyurethane adhesive locally at the leading edge and bonding it to the container,
activating the polyurethane adhesive locally at the trailing edge to form a sleeve formed in situ by bonding the trailing edge overlappingly onto the leading edge after rolling the label around the container,
shrinking the sleeve formed in situ as the shrink label over the article.

The seam between the edges of the label is formed and bonded before the shrinking process in both of the above described cases.

A shrink label according to the invention is characterized in that the label comprises at least a machine direction oriented polyolefin shrink film, an activatable polyurethane adhesive layer which is formed substantially over one surface of the shrink film, a printing which is formed over the polyurethane adhesive layer except for at least one edge of the label reserved for a seam to form a sleeve, and that said polyurethane adhesive is locally activatable at the non-printed edge of the label to form the sleeve, which is shrinkable over the article.

A shrink label material to be used in the method according to the invention is characterized in that the shrink label material is a machine direction oriented polyolefin film, which is coated substantially over one surface of the film with activatable polyurethane adhesive. The shrink label material is printable and after printing activatable in the non-printed areas to form a pre-formed sleeve or a sleeve formed in situ. The formed sleeve is shrinkable over the article.

The method according to the invention is based on the adhesive system which is applied to the polyolefin shrink film. The adhesive system is preferably one of polyurethane composition. The polyolefin film is coated substantially over the whole area of one surface with the activatable polyurethane adhesive. At room temperature this polyurethane adhesive layer is non-tacky, but it is activatable to become tacky. In addition, the adhesive is clear and displays good resistance to attack by solvents.

After the adhesive coating process, the adhesive-coated film is printed by gravure or flexographic inks, which are most often solvent-based, and the inks are dried. The film is fully printed over the non-activated adhesive layer with ink except for at least one edge which is left unprinted. The adhesive in the non-printed edge or edges can be activated by an external energy source to become tacky. In this tacky state of the adhesive, the edges of the label are bonded overlappingly together to form a sleeve which can be shrunk over the container. After the formation of the seam between the edges of the label, the adhesive changes to a non-tacky state, and thus a firm bond is formed. The adhesive strength of the bond is so great that it withstands any tendency for the seam to open even under high-shrink demand and at temperatures higher than 100° C.

Before activation, the adhesive coating is tack-free and non-sticky, and so the film coated with the adhesive can be wound up into reels and it can be transported easily without blocking of the rolls. Therefore, the further processing of the label material such as printing and label application (involving the activation of the adhesive) can be carried out in a different location.

The method according to the invention makes possible the use of high shrink demand labels, because of the firm joint between the edges of the label. It is also simpler and more convenient to use at the point of the label application than currently used systems.

Furthermore, the use of the polyurethane adhesive coating according to the invention allows that lower gauge filmic materials can be used due to the stability that it imparts to the system.

### DESCRIPTION OF THE DRAWINGS

The invention will be described in more detail with reference to appended drawings, in which

FIG. 1 shows a cross-sectional view of a shrink label according to the invention, and

FIG. 2 shows a cross-sectional view of another shrink label according to the invention.

### DETAILED DESCRIPTION OF THE INVENTION

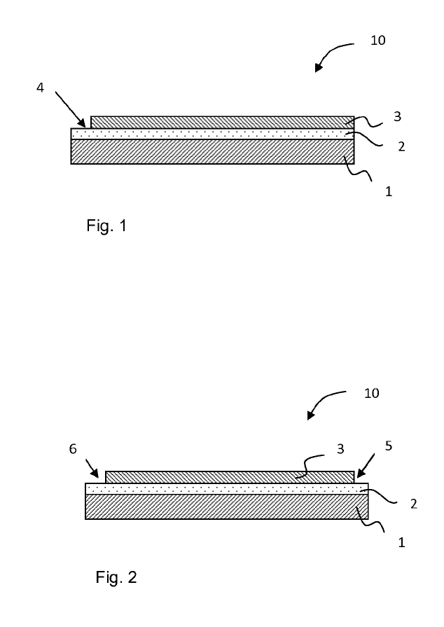

The invention will be described with reference to FIGS. 1 and 2, which show a cross-sectional view of the shrink labels according to the invention. The shrink label 10 comprises a machine direction oriented polyolefin shrink film 1, an adhesive layer 2 and a printing ink layer 3. One surface of the polyolefin film 1 is fully coated with the activatable polyurethane adhesive. After the formation of the adhesive layer 2, the printing ink layer 3 is formed over the adhesive layer except for at least one edge 4, 5, 6 of the film reserved for a seam to form a sleeve.

FIG. 1 illustrates the shrink label structure applicable in the case of the pre-formed label sleeve. The non-activated adhesive layer 2 is printed except for one edge 4 reserved for an overlapping joint to form a sleeve. After printing, the adhesive is activated in the non-printed edge 4 and the edge 4 is bonded to the opposite edge of the label to form the pre-formed sleeve, i.e. a tube or a cylinder, which can be arranged over the article. After having been arranged over the article, the sleeve is shrunk over the article.

FIG. 2 illustrates another shrink label structure, which is applicable in the case of a roll-applied shrink label, i.e. in the case of a sleeve formed in situ. The non-activated adhesive layer 2 is printed except for the leading edge 5 of the film to be attached to the article and for trailing edge 6 of the film reserved for a seam for bonding it to the leading edge. After printing, the label is arranged over the article and the sleeve is formed in situ so that first the adhesive is locally activated in the leading edge 5 and it is bonded to the article. Then, the adhesive is also locally activated in the trailing edge 6 and it is attached onto the top of the trailing edge 5 after rolling the label around the article. The activation of the edges 5, 6 can also be carried out at the same time. After sleeve formation, the sleeve is shrunk over the article.

The machine direction oriented polyolefin film may consist of a single layer, or it may comprise several layers which may be, for example, co-extruded or laminated layers. The thickness of the film can be about from 20 up to 70 microns.

The adhesive comprises polyurethane composition which is reversibly changeable from the non-tacky state to the tacky state. The adhesive may also comprise other polymers in addition to the polyurethane composition. The adhesive may include polymers, such as acrylic polymers, polyvinyl alcohol, ethylene/vinyl acetate copolymers or styrene/acrylate copolymers. The adhesive may also comprise inert fillers, tackifiers and/or plasticizers together with the polymer composition, such as the polyurethane composition.

The adhesive coated film may be printed by gravure or flexographics inks in order to form a printing ink layer which covers the whole surface of the adhesive layer except for at least one edge as is shown in FIGS. 1 and 2.

The adhesive is locally activated at the non-printed edge by an external energy source to a temperature between 50 to 90° C. that causes the adhesive layer to become tacky. The external energy source can be, for example, heat, infra red radiation, microwaves, laser, ultrasonic radiation or a combination of at least two of the above-mentioned means. The printed part of the label will not become tacky during the activation, because the adhesive is covered with printing ink.

Shrinking of the label over the article is carried out by feeding the labelled article through a shrink-tunnel at a high temperature causing the label to shrink and fit to the shape of the article, such as a container. Preferably, the label is shrunk over the container so that the printing remains between the shrink film and the container. Thus, the film protects the printing.

The label material and the shrink label according to the invention make it possible that the end user of the labels only needs to activate the adhesive in the non-printed edge or edges of label and after that the label can be arranged onto the labelled article. The label can be formed into the pre-formed sleeve before arranging it over the article, or the label can be rolled over the article and the sleeve is formed in situ. After sleeving, the label can be shrunk over the article.

1-12. (canceled)

13. A method for applying a shrink label to an article, the method comprising:
introducing a shrink label material comprising a machine direction oriented polyolefin shrink film coated substantially over one surface of the film with a non-activated activatable polyurethane adhesive;
printing the non-activated polyurethane adhesive layer of the label material except for at least one edge of the label material reserved for a seam to form a shrinkable label sleeve;
activating the polyurethane adhesive locally at the at least one edge of the label material that is not printed resulting in at least one non-printed edge and bonding edges of the label material to form the shrinkable label sleeve; and
shrinking the sleeve over the article.

14. The method according to claim 13, wherein the non-activated polyurethane adhesive layer of the label material is printed expect for one edge of the material reserved for an overlapping joint to form a sleeve.

15. The method according to claim 13, wherein the adhesive is activated at the at least one non-printed edge of the material and the edge is bonded to the opposite edge of the material to form a pre-formed sleeve.

16. The method according to claim 13, wherein the pre-formed sleeve is arranged over the article.

17. The method according to claim 13, wherein the non-activated polyurethane adhesive layer of the label material is printed expect for a leading edge to be attached to the container and for a trailing edge reserved for a seam for bonding the trailing edge to the leading edge.

18. The method according to claim 17, wherein the adhesive is activated at the non-printed edges, and the leading edge is bonded to the article and the trailing edge is attached on a top of the leading edge after rolling the film around the article.

19. The method according to claim 13, wherein the adhesive in the at least one non-printed edge is activated by at least one of heat, infra red radiation, microwaves, laser, or ultrasonic radiation.

20. The method according to claim 13, wherein the printing remains between the shrink film and the article.

21. The method according to claim 13, wherein the adhesive in the at least one non-printed edge is activated by at least two of heat, infra red radiation, microwaves, laser, or ultrasonic radiation.

22. A shrink label, comprising:
a machine direction oriented polyolefin shrink film;
an activatable polyurethane adhesive layer which is formed substantially over one surface of the shrink film; and
a printing which is formed over the polyurethane adhesive layer except for at least one edge of the label reserved for a seam to form a shrinkable label sleeve,
wherein said polyurethane adhesive is locally activatable at the non-printed edge of the label to form the sleeve, which is shrinkable over the article.

23. The shrink label according to claim 22, wherein the printing is formed over the polyurethane adhesive layer except for one edge of the label reserved for an overlapping joint to form a pre-formed sleeve.

24. The shrink label according to claim 22, wherein the printing is formed over the polyurethane adhesive layer except for a leading edge of the label to be attached to the article and for a trailing edge of the label reserved for a seam for bonding the trailing edge to the leading edge.

25. A shrink label material, comprising:
a machine direction oriented polyolefin film; and
activatable polyurethane adhesive that is coated substantially over one surface of the film.
